(19) United States
(12) Patent Application Publication
(10) Pub. No.: US 2007/0169515 A1
(43) Pub. Date: Jul. 26, 2007

(54) Processing method and processing apparatus of glass base material for optical fiber

(76) Inventors: Yuuji Tobisaka, Tokyo (JP); Waichi Yamamura, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 10/594,071

(22) PCT Filed: Mar. 7, 2005
(86) PCT No.: PCT/JP05/03923

§ 371 Date: Sep. 25, 2006

(30) Foreign Application Priority Data
Mar. 25, 2004 (JP) 2004-089614

(51) Int. Cl. C03B 18/00; C03B 37/014

(52) U.S. Cl. 65/404; 65/483

(57) ABSTRACT

Provided is a processing method and a processing apparatus of a glass base material, with which a welding process of a large glass base material and a process of forming ends of the glass base material into spindle shapes are easily and safely performed without causing core deviation or causing an accident of falling off of the glass base material. Provided is a processing method of processing a glass base material for an optical fiber using a processing apparatus, the processing apparatus including: a pair of rotatable chucks that directly or indirectly grasp respective ends of the glass base material in an axial direction of the glass base material and that are capable of performing relative displacement in an opposing direction; and a burner for heating the glass base material that is movable along the axial direction of the glass base material being grasped, the processing method being characterized by processing the glass base material while preventing the glass base material from being brought into a cantilever state by always holding or supporting the glass base material at two or more points. The processing apparatus includes at least one midway holding device that holds or supports midway part of the glass base material.

### TECHNICAL FIELD

The present invention relates to a processing method and a processing apparatus of a glass base material for an optical fiber, which is used as a raw material of the optical fiber. The present application claims priority from a Japanese Patent Application No. 2004-089614, filed on Mar. 25, 2004, the contents of which are incorporated herein by reference.

### BACKGROUND ART

An optical fiber is normally obtained by drawing a glass base material made of high-purity synthetic silica by a drawing apparatus in a predetermined diameter, and then by coating the surface of the resultant. The high-purity synthetic silica glass base material is formed into a glass base material for an optical fiber by dehydrating and vitrifying a porous glass base material created using a method such as a VAD (vapor phase axial deposition) method and an OVD (outside vapor deposition) method. Hereinafter, thus obtained glass base material for an optical fiber is simply referred to as “glass base material”. The glass base material tends to have bending and be of nonuniform diameter. Correction thereof is performed by heating in an electric furnace and an oxyhydrogen flame prior to a drawing process for transforming the glass base material into an optical fiber.

The glass base material specifically completes as a base material of an optical fiber by elongation into a diameter suitable for drawing using an electronic furnace, correction of bending and nonuniform diameter using an apparatus referred to as “glass lathe”, and then surface cleansing. Processing using a glass lathe aims to eliminate stains, small scratches, and the like caused on a surface of the glass base material during processing of the glass base material, in addition to correction of the diameter and the length of the glass base material. Processing of the glass base material is normally performed using a glass lathe as is illustrated in FIGS. 1 and 2. For efficient utilization of the entire length of the glass base material 1, glass supporting rods 2a and 2b are welded to the glass base material 1 at respective ends of the glass base material 1 in the axial direction of the glass base material 1. The glass base material 1 is mounted to the glass lathe by the chucks 3a and 3b grasping the glass supporting rods 2a and 2b.

The elongation process is performed in the following way. While the glass base material 1 is rotated around the axis thereof, the surface of the glass base material 1 is heated from one end thereof along the glass base material with the oxyhydrogen flame of the burner 4. A fixed rotation stand 6 and a movable headstock 7 are distanced from each other until the desired diameter is obtained while measuring the diameter with the diameter measurement device 5. Cleansing of the glass base material surface is performed by heating the surface by operating the burner 4 while rotating the glass base material with the distance between the fixed rotation stand 6 and the movable headstock 7 being maintained as above.

The actual processing procedure is as follows. First, as shown in FIG. 1, the glass supporting rod 2a, which is to be welded to one end of the glass base material 1, is grasped by the chuck 3a, faced against the glass base material 1 grasped by the chuck 3b so as to face the ends, and then the ends are heated by a burner 4, to bring the glass base material 1 and the glass supporting rod 2a into contact thereby pursuing welding. During this operation, if the welding is pursued with the cores being deviated from each other, the glass base material 1 will cause bending during processing even if the initial glass base material 1 has not had bending. With this in view, the cores are corrected as necessary for the purpose of preventing core deviation at the contacted portions.

Next, as shown in FIG. 2, the glass supporting rod 2b is welded to the other end surface of the glass base material 1. While the chuck 3a continues to grasp the glass supporting rod 2a to which welding has been performed first, the chuck 3b is released from the glass base material 1 and the glass base material 1 is removed from the movable headstock 7. Then the chuck 3b is made to grasp the glass supporting rod 2b to be welded next, and the facing ends are heated to weld the glass base material 1 and the glass supporting rod 2b. In this way, the glass supporting rods 2a and 2b are welded to the ends of the glass base material 1 respectively.

The elongation process is performed subsequent to this state. In the elongation process, the diameter correction for the glass base material 1 is performed by operating the burner 4 from one end and along the glass base material 1 for heating purpose, and elongating the glass base material 1 by moving the movable headstock 7. During this operation, the heated part is softened by adjusting the flame power and the operating speed of the burner 4 as necessary, and the diameter is adjusted by adjusting the moving speed of the movable headstock 7. After the glass base material 1 has undergone the elongation process and the diameter correction process, the ends of the glass base material are processed into a spindle shape suitable for a drawing start.

The process (hereinafter occasionally “spindle shape process”) of forming the ends of the glass base material 1 into a spindle shape is performed by heating the vicinity of an end of the glass base material 1, moving the movable headstock 7 while the burner 4 is halted, and elongating the heated part. As a result, the end of the glass base material 1 are formed into a spindle shape. During the processing, the burner 4 is slightly moved according to a desired form. In this processing, the end is not completely cut off. Instead, the elongation is stopped when the narrowest portion of the elongated part has reached 20-50 mm. The other end of the glass base material 1 is also processed into a spindle shape. After the both ends of the glass base material 1 have been formed into a spindle shape, tarnishes, dusts, and the like caused by silica powders remaining as a result of the processing are removed by flame polishing. Thereafter, the glass base material 1 is cut by fusing at the spindle-shaped portions at both ends, thereby completing a glass material ready for drawing. The diameter of the glass supporting rods to be held by the glass lathe is either the same level as or slightly thinner than the diameter of a raw material of the product, according to the thermal deformation at the welded portions. The length of the glass supporting rods is adjusted to such a level for the chucks and the rotation mechanisms of the chucks not to be broken. Specifically, the length is adjusted to approximately 300-900 mm, according to a relation with the flame power and the heat directed to the chuck portions during the processing.

### DISCLOSURE OF THE INVENTION

### Problems to be Solved by the Invention

Recently, the size of glass base material is becoming large, for the purpose of reducing the cost. To be more specific, as the length of an optical fiber that can be drawn at once gets long, the incurred time required per unit length is reduced. Furthermore, the drawing speed becomes faster and the productivity is raised, and so the expense regarding the drawing is restrained. For example, a conventional glass base material having a diameter of 50-80 mm and a length of 1000-1500 mm has an optical fiber length of 100-600 km. In comparison, if a glass base material is designed to have a diameter of 100 mm and a length of 1500 mm, an optical fiber length approaches 1000 km. Furthermore, if a glass base material has a diameter of 120 mm and a length of 1500 mm, an optical fiber length will be 1300 km or more.

However, when the glass base material gets large, a burden increases in the processing process prior to the drawing. For example, a raw material having a diameter of 80 mm and a length of 1500 mm has a weight of about 20 kg. In contrast, a raw material having a diameter of 120 mm and a length of 1500 mm has a weight of 40 kg or more. In addition, the weight of the glass supporting rods that are to be welded to both ends during processing has to be taken into account, too. Such weight increase substantially impedes the processing.

As the glass base material gets large, the weight and the length thereof accordingly increase. As a result, the stress at the chucks that grasp the ends increases as well. Each such grasping part is provided with a buffer material for preventing scratches on glass. However the grasping width is about 100 mm which is short compared to the length of the glass base material. Therefore when a glass base material is in a cantilever state (i.e. when the glass base material is held at one end thereof, or at an end of a glass supporting rod welded to the glass base material), a slight inclination is caused at the grasping part by the incurred weight.

During welding of a glass supporting rod, the length of about 1500-2000 mm is brought into the cantilever state. Therefore if there is even a slight inclination at the grasping part, the end of the glass base material to be welded will experience a large deviation from the central axis line of the chucks. Such deviation remains as it is after the welding. The deviation appears as bending during the elongation process and the spindle shape process. In this case, a further bending correction process has to be performed. Such bending causes problems during drawing. For example, a glass base material is subjected to uneven heating in the furnace, or the glass base material comes into contact with the inside of the furnace. Therefore, existence of bending is an important inspection item regarding a glass base material.

When the glass base material is held in the cantilever state, even when a tip of the glass base material does not initially deflect while being rotated, inclination by gravity tends to gradually increase due to change in load position of the grasping part during rotation. When a large and long thing is left rotating in the cantilever state for a long time, it occasionally happens that the deflect at a tip of the thing gradually increases.

After a glass supporting rod is welded to one end of a glass base material, a chuck that used to hold the glass base material is released to make the chuck hold the glass supporting rod in turn for the purpose of performing welding to the other end of the glass base material. During this operation, too, the cantilever state is caused and deflect (deviation) at a tip increases before the welding completes.

In addition, a glass supporting rod used for the processing is made of silica glass and so is expensive. A thick glass supporting rod incurs further expense, and so is repeatedly used. As repeatedly used, a glass supporting rod will have scratches on the surface. When scratches are caused on a grasping part, the glass supporting rod will break at the grasping part, thereby leading to falling off of the welded glass base material and to breakage. This further leads to breakage of the apparatuses, and therefore produces other problems in terms of safety, yield, and the like.

An object of the present invention is to provide a processing method and a processing apparatus of a glass base material, with which the welding process and the spindle shape process are easily and safely performed without core deviation and without causing an accident of falling off of the glass base material.

### Means for Solving the Problems

The present invention provides a processing method of processing a glass base material for an optical fiber using a processing apparatus, the processing apparatus including: a pair of rotatable chucks that directly or indirectly grasp respective ends of the glass base material in an axial direction of the glass base material and that are capable of performing relative displacement in an opposing direction; and a burner for heating the glass base material that is movable along the axial direction of the glass base material being grasped, the processing method being characterized by processing the glass base material while preventing the glass base material from being brought into a cantilever state by always holding or supporting the glass base material at two or more points. In addition, the processing apparatus includes at least one midway holding device that holds or supports midway part of the glass base material. Here, “midway part” of the glass base material indicates any part of the glass base material except for the both ends thereof. It is also possible that at least one of the two or more points at which the glass base material is held or supported is midway part of the glass base material. Further, two or more of the two or more points may also be midway part of the glass base material.

A processing apparatus of a glass base material for an optical fiber according to the present invention is a processing apparatus that processes a glass base material for an optical fiber, the processing apparatus comprising: a pair of rotatable chucks that directly or indirectly grasp respective ends of the glass base material in an axial direction of the glass base material and that are capable of performing relative displacement in an opposing direction; and a burner for heating the glass base material that is movable along the axial direction of the glass base material being grasped; and at least one midway holding device that holds or supports midway part of the glass base material.

A supporting mechanism of a holing part provided for the midway holding device has an absorption mechanism that absorbs power from the glass base material. The absorption mechanism may include a spring or an air cylinder for receiving load from the glass base material. According to the stated structures, more than necessary power is prevented from being imposed upon the glass base material, thereby preventing breakage of the glass base material. In addition, the holding part may include a heat resistant roller. The heat resistant roller may be a roller made of carbon.

In addition, the midway holding part may be movable along the axial direction of the glass base material being grasped. With the mentioned arrangements, it becomes possible to swiftly move the midway holding part to an arbitrary position of the glass base material for holding the glass base material, with a simple structure. In addition, in such processes as flame polishing, the midway holding part is able to be escaped to the chuck side.

### Effect of the Invention

According to the glass base material processing method according to the present invention, the glass base material or the glass supporting rod is always supported by two or more points when processing a large glass base material using a glass lathe. Therefore, a cantilever state is prevented from being caused. Accordingly, progression of bending attributable to axis deviation is prevented thereby enabling to obtain a glass base material without serious bending. In addition, stress at the chuck portion is alleviated, thereby lessening anxiety of falling off of the glass base material due to breakage, to facilitate safe manufacturing thereof.

### BRIEF DESCRIPTION OF THE DRAWINGS

FIG. 1 is a schematic explanatory diagram showing a manner of welding a glass supporting rod to one end of a glass base material using a conventional glass lathe.

FIG. 2 is a schematic explanatory diagram after glass supporting rods have been welded to respective ends of a glass base material, using a conventional glass lathe.

FIG. 3 is a schematic explanatory diagram showing a manner of welding a glass supporting rod to one end of a glass base material, using a method according to the present invention.

FIG. 4 is a schematic explanatory diagram showing a manner of welding a glass supporting rod to the other end of the glass base material after a glass supporting rod has been welded to the one end of the glass base material.

FIG. 5 is a schematic explanatory diagram showing a manner of processing one end of the glass base material into a spindle shape, using a method according to the present invention.

FIG. 6 is a schematic diagram showing a state in which a glass base material is held by a midway holding device.

FIG. 7 is a schematic diagram showing a different example of the state in which the glass base material is held by a midway holding device.

### BEST MODE FOR CARRYING OUT THE INVENTION

The following description explains the present invention with embodiments. The embodiments described below do not limit the invention claimed herein. All of the combinations described on the embodiments are not essential to the solutions of the present invention.

As described above, size increase of the glass base material also indicates increase in length and weight. This causes a problem in holding the glass base material in a cantilever state during processing. So as to prevent this problem, while being processed, the glass base material is held always at two or more points, without bringing the glass base material into a cantilever state. To be more specific, the cantilever state is prevented during processing by providing one or more midway holding devices that hold the glass base material at least at one midway part, the midway holding devices being provided independently of a pair of rotatable chucks that directly or indirectly grasp respective ends of the glass base material in an axial direction of the glass base material and that are capable of performing relative displacement in an opposing direction.

According to this arrangement, it becomes possible to prevent troubles of breakage of the glass base material or of the glass supporting rod(s) attributable to misalignment of a corresponding tip and concentration of stress at the grasping part by a chuck incident to the cantilever state of the glass base material. Note that “midway part” of the glass base material indicates any part of the glass base material except for the both ends thereof.

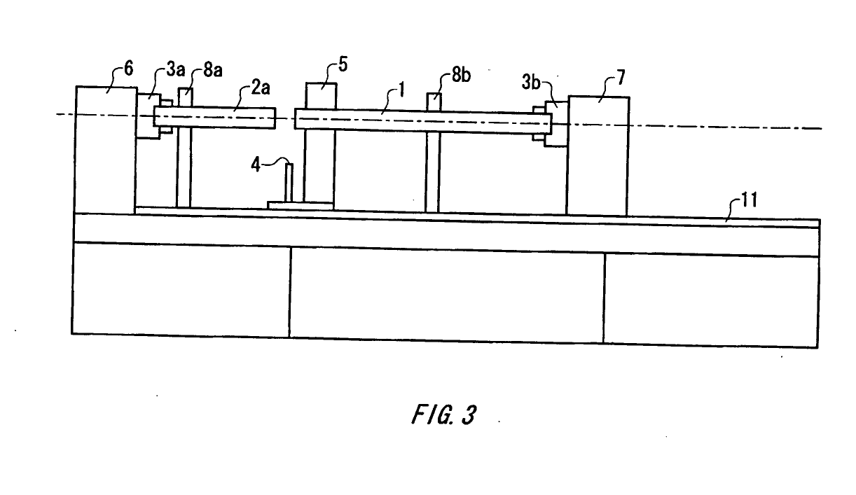

As FIGS. 3-5 show, during operations in which a long glass base material could be held in a cantilever state, the midway holding device functions to hold a midway part of the glass base material and to prevent occurrence of the cantilever state. These drawings indicate provision of two midway holding devices (8a, 8b). However, the number of the midway holding device is not limited to two. Depending on the flow processing procedure, there may be one midway holding device, or three or more midway holding devices. However, in the present invention it is important to hold a glass base material at two or more points. With this in view, it is necessary that two or more supporting points are ensured by the midway holding device(es) and the chucks positioned at both ends, under a condition where the cantilever state is likely to occur during processing, e.g. under a condition of releasing one chuck. After releasing a chuck and until either welding or the chuck grasps the glass base material again, the glass base material has to be held by the midway holding device without being brought into a cantilever state.

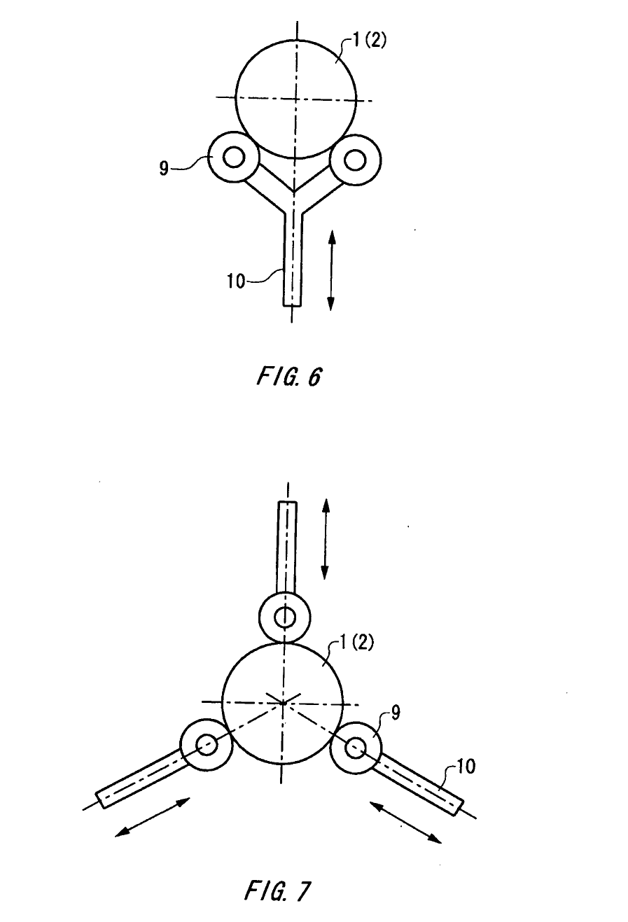

A holding part of the midway holding device, used to hold a midway part of the glass base material, is not necessarily be as fast as conventionally used chucks. In fact, it is sufficient if the holding part has a mechanism that aligns the central axis of the glass base material to the center of the chucks positioned at the both ends as well as being capable of supporting the weight of the glass base material. In addition, it is preferable that the holding part is provided with a roller having heat resistance, and the like, which is able to operate in accordance with the rotation of the glass base material. For example, as shown in FIG. 6, the midway holding device may be provided with a supporting arm 10 with two rollers 9. The supporting arm 10 is capable of holding the glass base material 1 with the two rollers 9, by moving up and down with respect to the central axis of the chucks.

There are several methods for aligning the central axis of the glass base material 1 to the central axis of the chucks at the both ends. For example, one type of the methods uses a diameter measurement device, a laser position detection sensor, and the like. In another type of the methods, as FIG. 7 shows, a plurality of supporting arms 10 are provided for the midway holding device, and the alignment is achieved by moving the supporting arms 10 towards the central axis of the chucks, and by sandwiching the glass base material 1 by the rollers 9 positioned at the tips of the arms. To prevent breakage of the glass base material due to more than necessary power being imposed thereon, it is preferable that the holding part has such a supporting mechanism as holding the weight of the glass base material via a spring or an air cylinder.

As follows, the present invention is described in greater details according to the processing procedures, with reference to the drawings. However, the present invention is not limited to the following described procedures. Modifications are possible in which the procedures, the attachment direction and number of the glass supporting rods are changed according to the completed form of the glass base material.

The holding part of the midway holding device is for example provided with three supporting arms 10 with a respective roller 9, and each supporting arm 10 is arranged to move with a constant interval therebetween towards the chucks by means of a link structure (not illustrated in the drawings). The driving source of moving is an air cylinder not illustrated in the drawings. The holding power is arranged to be adjusted by a supplied pressure. Each roller 9 has a diameter of 75 mm and a thickness of 10 mm, and is made of carbon.

First, as shown in FIG. 3, one end of the glass base material 1 is grasped by the chuck 3b, and a midway part of the glass base material 1 is held by the midway holding device 8b. In this state, a free end surface of a glass supporting rod 2a grasped by the chuck 3a and a free end surface of the glass base material 1 are heated using a burner 4. Then a movable headstock 7 is moved so that the free end surfaces of the glass supporting rod 2a and the glass base material 1 come in contact with each other, thereby welding the glass supporting rod 2a to one end of the glass base material 1.

Note that the welding of the glass base material 1 is performed as follows. Using a transportation apparatus not illustrated in the drawings, the glass base material 1 is transported between the midway holding device 8b at the right side and the chuck 3b, to be supported by both of the midway holding device 8b and the chuck 3b. The welding is performed in this state.

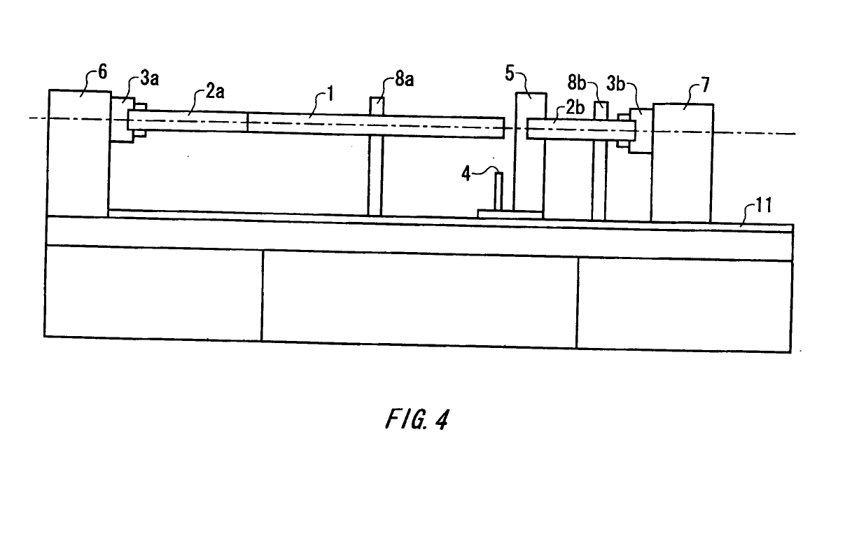

After the welding, the glass base material 1 is temporarily released from the midway holding device 8b, and the burner 4, the diameter measurement device 5, and the two midway holding devices 8a, 8b are moved away. Then a midway part of the glass base material 1 is held again by the midway holding device 8a at the left side. According to the mentioned arrangement, even if the chuck 3b is released for welding the glass supporting rod 2b to the other end of the glass base material 1, the glass base material 1 will not be brought into the cantilever state (Refer to FIG. 4).

Next, as FIG. 4 shows, while keeping a state in which the glass base material 1, to one end of which the glass supporting rod 2a has been welded, is supported by the chuck 3a and the midway holding device 8a at the left side, the glass supporting rod 2b is set to the chuck 3b. Then the ends respectively of the glass base material 1 and the glass supporting rod 2b are heated by the burner 4, and the movable headstock 7 is moved so that the end surfaces of the glass base material 1 and the glass supporting rod 2b come in contact with each other, thereby welding together the glass base material 1 and the glass supporting rod 2b.

In this way, the glass supporting rods 2a and 2b are linked to the ends of the glass base material 1, respectively, and the glass supporting rods 2a and 2b are grasped by the chucks 3a and 3b, thereby bringing the glass base material 1 into a center impeller state.

It is desirable that the midway holding device has such a structure as is movable in the direction of the axis of the glass base material, in accordance with the moving of the glass base material and the glass supporting rods, so as to be moved aside to a safe area in the elongation process and the flame polishing process when the burner is operated back and forth the whole area.

In the examples shown in FIGS. 3-5, the midway holding devices 8a and 8b are mounted on a slide rail 11 of the lateral movement mechanism. Because the burner 4 and the diameter measurement device 5 are also provided on the slide rail 11, the midway holding devices 8a and 8b cannot move ahead the burner 4. For this reason, the midway holding devices 8a and 8b are placed on the left and right of the burner 4, respectively.

If, for example, the midway holding devices 8a and 8b are provided for a lateral movable mechanism different from the movable headstock 7, the midway holding devices 8a and 8b are movable to each of the right and left of the burner 4. In this case, a single midway holding device would be sufficient. However it is still desirable to provide two or more midway holding devices in view of shifting the midway holding position from one point to another. According to this arrangement, it becomes possible to hold a long and large glass base material 1 at two or more midway points.

The elongation process that shortens the diameter of the glass base material is performed by keeping the mentioned state. However except during a first phase of heating where the movable headstock is not moved, it is not necessary to hold a midway part of the glass base material 1 because tensile stress is exerted in the lateral direction and so the possibility that the glass base material 1 hangs down is low. With this in view, it is preferable to move the midway holding device 8a at the left side to the vicinity of the fixed rotation stand 6, and the midway holding device 8b at the right side to the vicinity of the movable headstock 7. This arrangement is preferable also because the midway holding devices tend to be in the way of the burner 4 while it is being operated, and sometimes breaks due to the radiation heat from the glass base material 1 after being processed.

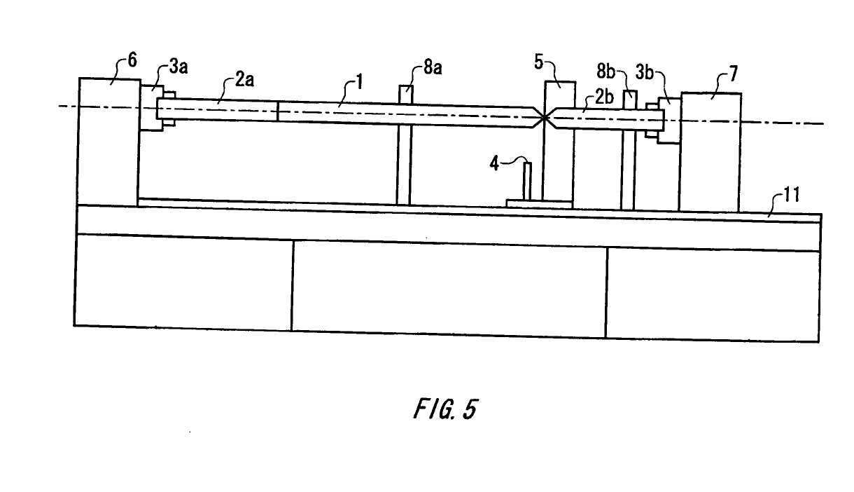

When processing an end of the glass base material 1 in a spindle shape, as FIG. 5 shows, the midway holding device 8a at the left side is used to hold a midway part of the glass base material 1, and the movable headstock 7 is moved to the right side while heating the vicinity of the right end of the glass base material 1. When processing the left end of the glass base material 1 into the spindle shape, the processing is performed with a midway part of the glass base material 1 being held by the midway holding device 8b positioned at the right side. Since the spindle shape process is performed by heating and softening part of the glass base material, the softened part cannot bear the whole weight to cause hanging of the glass base material at the softened part just as when the glass base material is held in a cantilever state. Therefore, even though the chucks are grasping the both ends of the glass base material, in such cases as heating continues for only a part of the glass base material, it becomes necessary to hold the glass base material at left and right of the heated portion, or a longer side of the glass base material with respect to the heated portion, with use of the midway holding devices.

When pursuing a flame polishing process, the burner 4 being a heating source has to be operated back and forth just as in the elongation process. Therefore the midway holding devices 8a and 8b are also escaped to the vicinity of the chucks.

In case of pursuing the flame polishing process after completion of the spindle shape process, a midway part of the glass base material 1 may desirably be held by the midway holding device 8a or the midway holding device 8b, so as to prevent a narrowed spindle-shaped portion from hanging down, depending on the diameter of the spindle-shaped portion.

For dismounting from the glass lathe the glass base material 1 having undergone the processing, the procedure reverse to the procedure performed for mounting the glass base material 1 to the glass lathe may be performed. Specifically, the dismounting is performed by transporting a transportation apparatus to where the glass base material is held by the chucks and the midway holding devices, mounting the glass base material on the transportation apparatus, and releasing the chucks and the midway holding devices. In this way, a long glass base material is always held at two or more points by the midway holding devices in addition to the conventional chucks. With this arrangement, the cantilever state of the glass base material is prevented. Accordingly, it becomes possible to manufacture a glass base material that is long, large, and without serious bending.

### EMBODIMENT EXAMPLES

### Embodiment Example 1

A glass base material was processed using a glass lathe as shown in FIG. 3.

First, a glass supporting rod 2a having a diameter of 100 mm and a length of 800 mm and a glass base material 1 having a diameter of 105 mm and a length of 1700 mm were welded together in the following manner. While rotating the glass supporting rod 2a grasped by a chuck 3a and the glass base material 1 held by a chuck 3b and a midway holding device 8b at the right side, opposing end surfaces respectively of the glass supporting rod 2a and the glass base material 1 were heated and brought into contact with each other.

Next, while the glass base material 1 was grasped by the chuck 3a, the midway holding device 8b at the right side was released and is escaped to the vicinity of the chuck 3b. Then after holding the same position of the glass base material 1 by the midway holding device 8a at the left side, the chuck 3b was released.

Subsequently, the glass supporting rod 2b having a diameter of 100 mm and a length of 800 mm was grasped using the chuck 3b as FIG. 4 shows. Then after heating opposing end surfaces of the glass supporting rod 2b and the glass base material 1, the both end surfaces were made to be in contact with each other, thereby welding the glass supporting rod 2b to the other end of the glass base material 1. After the welding, the midway holding device 8a at the left side was released, and was escaped to the vicinity of the chuck 3a. Then the elongation process that shortens the diameter of the glass base material 1 to 100 mm was performed.

After the elongation process, as FIG. 5 shows, while holding a midway part of the glass base material 1 by the midway holding device 8a at the left side, the right end of the glass base material 1 was processed into a spindle shape. This process was ended when the minimum diameter reached about 35 mm, without performing the final cutting. After the processed spindle-shaped portion was cooled down, the midway holding device 8a at the left side was released, and in turn the midway holding device 8b was used to hold a midway part of the glass base material 1, and the left end of the glass base material 1 was processed into the spindle shape. After the spindle-shaped portion was cooled down, the midway holding device 8b at the right side was released.

In this way, the both ends of the glass base material 1 were formed into the spindle shape. Then flame polishing is performed while operating the burner 4 being a heating source in the direction to the left spindle-shaped portion from the right spindle-shaped portion. During the flame polishing, the midway holding devices 8a and 8b were not used. However the hanging down of the spindle-shaped portion did not occur.

After the flame polishing, while holding a midway part of the glass base material 1 using the midway holding device 8b at the right side, the left spindle-shaped portion of the glass base material 1 was cut by fusing. In this state, the glass base material 1 was mounted on the transportation apparatus. Then the midway holding device 8b was released, and the right spindle-shaped portion was cut by fusing. Then the glass base material 1 was demounted from the apparatus.

The bending of the resulting glass base material was found to maintain the same level as before the processing. In addition, the center of the spindle-shaped portion was confirmed to match the central axis of the glass base material.

### Comparison Example 1

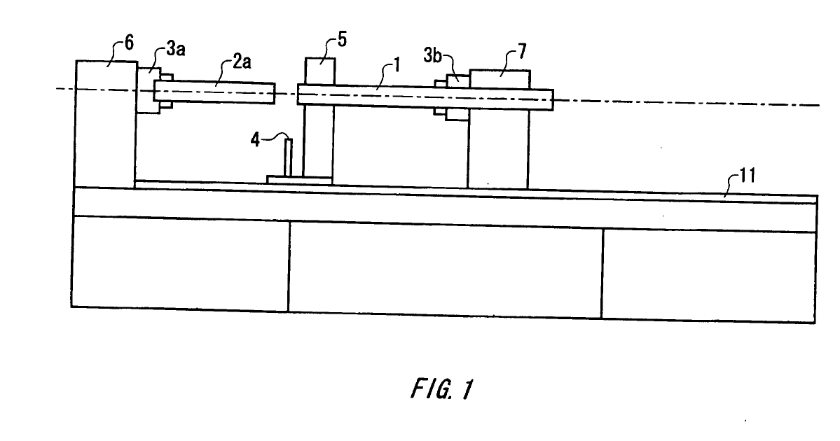

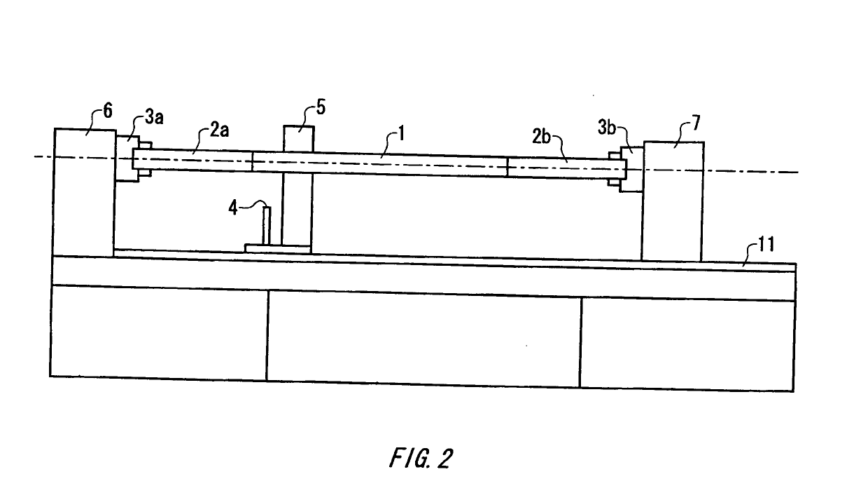

A glass base material was processed using a glass lathe as shown in FIG. 1. First, a glass supporting rod 2a having a diameter of 100 mm and a length of 600 mm and a glass base material 1 having a diameter of 105 mm and a length of 1700 mm were welded together in the following manner. While rotating the glass supporting rod 2a grasped by a chuck 3a and the glass base material 1 held by the chuck 3b, opposing end surface respectively of the glass supporting rod 2a and the glass base material 1 were heated and brought into contact with each other. Subsequently, the chuck 3b was released. Using this chuck 3b, the glass supporting rod 2b having a diameter of 100 mm and a length of 600 mm was grasped, thereby attempting to weld the glass supporting rod 2b to the other end of the glass base material 1 too.

The glass base material 1 had a bending of 0.2 mm, and an estimated deflect of the tip was within 0.4 mm. However, as being rotated, the glass base material 1 underwent a larger deflect, which has reached 1.6 mm. The deflect of the tip was corrected in the following way. The chuck 3a was fastened tighter, the vicinity of the welded portion between the glass supporting rod 2a grasped by the chuck 3a and the glass base material 1. Then while applying a roller in the vicinity of the other end of the glass base material that is unheld, the correction of the tip deflect was pursued. After correcting the tip deflect, a glass supporting rod was welded to the other end of the glass base material.

After the glass supporting rods 2a and 2b have been welded to the ends of the glass base material 1 respectively, the result was elongated to shorten the diameter to 100 mm. Further, the ends of the glass base material 1 were processed into a spindle shape. There was no particular problem in the elongation process. During the spindle shape process, however, the heated portion of the glass base material 1 hung down, thereby deviating the narrowed portion from the center of the glass base material 1. The spindle shape process was performed by heating to soften one point of the glass base material using a burner flame. The above-mentioned problem is attributed to hanging down of the softened portion of the glass base material that is long, due to gravity.

When the glass base material created in the above way was used for drawing, the glass base material came into contact with the inside of the furnace.

### Comparison Example 2

A glass base material was processed using a glass lathe as shown in FIG. 1. First, a glass supporting rod 2a having a diameter of 95 mm and a length of 500 mm and a glass base material 1 having a diameter of 104 mm and a length of 1600 mm were welded together in the following manner. While rotating the glass supporting rod 2a grasped by a chuck 3a and the glass base material 1 grasped by a chuck 3b, opposing end surfaces respectively of the glass supporting rod 2a and the glass base material 1 were heated and brought into contact with each other. Subsequently, a glass supporting rod was attempted to be welded to the other end of the glass base material 1 too.

The glass base material 1 had a bending of 0.8 mm having an arc shape. It becomes necessary to measure the position and amount of the bending for correction thereof. In view of this, while rotating the glass base material 1, the diameter measurement device 5 was operated in the lengthwise direction of the glass base material 1. During this operation, the glass supporting rod 2a grasped by the chuck 3a was cracked immediately ahead of the chuck, leading to falling off of the glass base material 1 to breakage. The breakage of the glass supporting rod 2a is attributable to growth of scratches having already been caused on the surface of the glass supporting rod as a result of the concentration of stress at the immediately ahead of the chuck.

### Industrial Applicability

According to the present invention, the processing accuracy of glass base materials improve and yield is raised, to contribute to cost reduction.

1. A processing method of processing a glass base material for an optical fiber using a processing apparatus, the processing apparatus including: a pair of rotatable chucks that directly or indirectly grasp respective ends of the glass base material in an axial direction of the glass base material and that are capable of performing relative displacement in an opposing direction; and a burner for heating the glass base material that is movable along the axial direction of the glass base material being grasped, the processing method being characterized by processing the glass base material while preventing the glass base material from being brought into a cantilever state by always holding or supporting the glass base material at two or more points.

2. The processing method according to claim 1, wherein the processing apparatus includes at least one midway holding device that holds or supports midway part of the glass base material.

3. The processing method according to claim 1, wherein at least one of the two or more points at which the glass base material is held or supported is midway part of the glass base material.

4. The processing method according to claim 1, wherein the glass base material is held at two or more midway parts.

5. A processing apparatus that processes a glass base material for an optical fiber, the processing apparatus comprising: a pair of rotatable chucks that directly or indirectly grasp respective ends of the glass base material in an axial direction of the glass base material and that are capable of performing relative displacement in an opposing direction; and a burner for heating the glass base material that is movable along the axial direction of the glass base material being grasped; and at least one midway holding device that holds or supports midway part of the glass base material.

6. The processing apparatus according to claim 5, wherein a supporting mechanism of a holing part provided for the midway holding device has an absorption mechanism that absorbs power from the glass base material.

7. The processing apparatus according to claim 6, wherein the absorption mechanism includes a spring or an air cylinder for receiving load from the glass base material.

8. The processing apparatus according to claim 5, wherein the holding part includes a heat resistant roller.

9. The processing apparatus according to claim 8, wherein the heat resistant roller is a roller made of carbon.

10. The processing apparatus according to claim 5, wherein the midway holding part is movable along the axial direction of the glass base material being grasped.

11. The processing method according to claim 2, wherein the glass base material is held at two or more midway parts.

12. The processing method according to claim 3, wherein the glass base material is held at two or more midway parts.

13. The processing apparatus according to claim 6, wherein the holding part includes a heat resistant roller.

14. The processing apparatus according to claim 7, wherein the holding part includes a heat resistant roller.
